(19) United States
(12) Patent Application Publication
(10) Pub. No.: US 2017/0038854 A1
(43) Pub. Date: Feb. 9, 2017

(54) SENSOR ASSEMBLY

(71) Applicant: HEWLETT-PACKARD DEVELOPMENT COMPANY, LP., HOUSTON, TX (US)

(72) Inventors: MICHAEL DELPIER, (US); DUSTIN HOFFMAN, (US); DIMITRE MEHANDJIYSKY, HOUSTON, TX (US)

(21) Appl. No.: 15/303,552

(22) PCT Filed: Apr. 30, 2014
(86) PCT No.: PCT/US2014/036088

§ 371 Date: Oct. 12, 2016

(51) Int. Cl. G06F 3/02; G06F 1/16; G06F 3/023

(52) U.S. Cl. CPC G06F 3/021; G06F 3/0231; G06F 1/1669; G06F 1/1618

(57) ABSTRACT

An apparatus comprises an interface platform for being removably attached to a deck of a computer device. The interface platform comprises a transmitter to seed signals to and receive signals from the computer device, a first face having a first user interface; and a second face having a second user interface different than the first user interface.

### BACKGROUND

Keyboards are often used to provide input to a computing device. In some circumstances, specialized input devices are additionally used.

### BRIEF DESCRIPTION OF THE DRAWINGS

FIG. 1 schematically illustrates an example interface platform for a computer device.

FIG. 2 schematically illustrates an example deck for use with the interface platform of FIG. 1.

FIG. 3 schematically illustrates an example computer device comprising an implementation of the interface platform of FIG. 1 in a first orientation and an implementation of the deck of FIG. 2.

FIG. 4 schematically illustrates the computer device of FIG. 3 with the interface platform and a second different orientation.

FIG. 5 is a flow diagram of an example method that may be carried out by the computer device of FIG. 3.

FIG. 6 is a schematic diagram of another implementation of the computer device of FIG. 3.

FIG. 7 is a top view of an example overlay for use with the computer device of FIG. 6.

FIG. 8 is a top view of mother example overlay for use with the computer device of FIG. 6.

FIG. 9 is a perspective view of another example implementation of the computer device of FIG. 6.

FIG. 10 is a top view of an example deck of the computer device of FIG. 9 with portions schematically illustrated.

FIG. 11 is a top perspective view of an example interface platform of the computer device of FIG. 9.

FIG. 12 is an exploded perspective view of another example imitation of the computer device of FIG. 6.

FIG. 13 is a top perspective view of an example interface platform of the computer device of FIG. 12.

FIG. 14 is a bottom perspective view of the interlace platform of FIG. 13.

FIG. 15 is a perspective view of the interface platform of FIG. 13 being utilized with another example computer device.

### DETAILED DESCRIPTION OF THE EXAMPLE EMBODIMENTS

FIG. 1 schematically illustrates an example user input interface platform 30. Platform 30 is configured to be removably attached, mounted to or retained in place relative to a deck of a computer device. In one implementation, the deck of the computer device comprises a base of a notebook computer from which the display panel pivotably extends. In other implementation, the deck may be contained within a same housing as that which contains the display of the computer device. As will be described hereafter, the single platform 30 provides the computer device with multiple different user interfaces dependent upon an orientation of platform 30 or positioning of platform 30 relative to the deck.

Platform 30 comprises a first face 32 having a first user interface 34, a second opposite face 36 having a second user interface 38 and a transmitter 40. User interface 34 extends along face 32 while user interface 38 extends along face 36. In the example illustrated, user interfaces 34, 38 each comprise one or more tactile sensing regions which sense the touch of a person against such regions. In another implementation, interface 34, 38 each comprise keys which are resiliently biased to a raised state by magnets or springs. In one implementation, one or both of interface 34, 38 may comprise optical sensing devices that utilize captured images of motion by hands or fingers of a person to produce signals serving as input. In one implementation, user interfaces 34, 38 comprise different types of sensing regions. For example, in one implementation, user interface 34 may comprise a plurality of manually depressable individual keys which are resiliency biased to raised positions by springs, magnets or other devices. In such an implementation, user interface 38 comprises a tactile sensing region which senses the mere touch or contact against such regions, similar to a touchpad or touchscreen technology. In one implementation, one or both of interfaces 34, 38 comprises a touch screen.

Interfaces 34 and 38 provide different layouts or arrangements of input elements by which a user may input selections, data and commands. In one implementation, user interfaces 34 and 38 comprise different layouts of manually depressable keys. For example, in one implementation, interface 34 may comprise a QWERTY style keyboard interface 30 comprises a different style keyboard. In one implementation, interface 34 comprises a keyboard for a first language while interface 38 comprises a keyboard for a second different language. In one implementation, interface 34 comprises a layout of individual keys associated with alphanumeric characters while interface 38 comprise a layout of individual keys having braille indicators or bumps.

Transmitter 40 comprises a mechanism in communication with interfaces 34, 38, wherein transmitter 40 transmits signals based upon interactions with interfaces 34, 38 to a driver and/or processor of the computing device. In one implementation, transmitter 40 transmits such signals to a transmitter associated with the deck of the computing device. In other implementations, transmitter 40 transmits such signals to another portion of the computing device such as when the transmitter and/or processor of the computing device is located in the display panel or another housing. Transmitter 40 is configured to transmit such signals regardless of the orientation of platform 30, whether interface 34 is facing up or whether interface 38 of facing up. In yet other implementations, each of interfaces 34, 38 may have its own assigned separate transmitter 40.

In one implementation, transmitter 40 is configured to transmit such signals to a processor of the computer device in a wireless fashion. For example, in one implementation, transmitter 40 comprises a Bluetooth transmitter, sending signals to and receiving signals from the remainder of the computer device in a wireless fashion. In another implementation, transmitter 40 utilize other wireless transmission technologies such as other optical (infrared, or the like) or other radio wave signal transmission technologies.

In another implementation, transmitter 40 may comprise a male or female plug or a series of connector pins or pads which are automatically connected to or placed in contact with a corresponding plug or connector pins/pads of the deck when platform 30 is secured to the deck. For example, in one implementation, one of the platform 30 and the associated deck receives the other of the platform 30 and the associated deck, wherein during such reception, the plugs or pins of platform 30 automatically connect to the corresponding plugs or pins of the deck. In still other implementations, transmitter 40 may comprise a communication cable which extends from platform 30 to the deck.

In use, a user may select which of the two interfaces 34, 38 are to be used by simply flipping platform 30 such that the selected interface 34, 38 faces upwards for use while the other of interfaces 34, 38 faces the underlying deck. In some implementations, the selected orientation of platform 30 is automatically detected by the computer device, wherein the computer device automatically associates signals received from transmitter 40 for the chosen interface 34, 38 with the correct corresponding input signal values. In other implementations, the computer device prompts the user to indicate or identify which of interface 34, 38 has been selected and is presently being used. For example, in one implementation, the deck, interface platform 30, the display panel or another portion of the computer device may include a toggle switch or rocker switch by which the user may indicate which of the two interfaces 34, 38 is presently facing upwards and is presently being used.

FIG. 2 schematically illustrates an example deck 110 for use with at least one user interface platform, such as user interface platform 30 described above with respect to FIG. 1. As shown by FIG. 2, deck 110 comprises body 112, platform retainer 114 and transmitter 116. In one implementation, deck 112 additionally comprises processor 118 and memory 120. Body 112 comprises a housing containing remaining components of deck 110. Body 112 is configured to support an interface platform, such as interface platform 30. In one implementation, body 112 is pivotally coupled to a display panel which pivots between a retracted position along deck 112 and an extended position elevated or projecting above deck 112. In another implementation, body 112 houses and contains a display panel.

Platform retainer 114 comprises one or more mechanisms to releasably secure or mount and retain an interface platform, such as interface platform 30, relative to deck 112. In one implementation, platform retainer 114 comprises a recess into which platform retainer 30 is at least partially received. In another implementation, platform retainer 114 comprises one or more posts, columns or other projections which are received within corresponding cavities or bores of an interface platform. In yet another implementation, platform retainer 14 may comprise one of a tongue and groove, wherein interface platform comprise other of the tongue and groove, facilitating sliding interconnection and interlocking of deck 110 with the interface platform. In yet other implementations, platform retainer 114 may comprise other mechanisms such as latches, snaps, clips or the like to releasably securing an interface platform in place relative to deck 110.

Transmitter 116 is configured to transmit signals to and receive signals from an associated interface platform, such as interface platform 30. In one implementation, transmitter 116 facilitates wireless communication with the associated interface platform 30. In one implementation, transmitter 116 comprises a Bluetooth transmitter, sending signals to and receiving signals an interface platform. In another implementation, transmitter 116 utilizes other wireless transmission technologies such as other optical (infrared or the like) or other radio wave signal transmission technologies.

In another implementation, transmitter 116 comprises a male or female plug or a series of connector pins or pads which are automatically connected to or placed in contact with a corresponding plug or connector pins/pads of the deck when platform 30 is secured to the deck 110. For example, in one implementation, one of the platform 30 and the associated deck receives the other of the platform 30 in the associated deck, wherein during such reception, the plugs or pins of platform 30 automatically connect to the corresponding plugs or pins of the deck. In still other implementations, transmitter 116 may comprise a communication cable which extends from deck 110 to the interface platform 30.

Processor 118 comprises one or more processing units in communication with transmitter 116. Processing unit 118, following computer-readable instructions, code or programming contained in non-transitory memory 120, translates such signals received from transmitter 116 (signals being generated in response to interactions with one of the two interfaces 34, 38 of interface platform 30) into data, selections or commands. In other implementations, processor 118 and memory 120 may be located in other portions of the computing device, such as in the display panel, wherein signals from transmitter 116 are transmitted to the processor in the display panel.

For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, processor 118 and memory 120 may be entirely or partially embodied as part of one or more application-specific integrated circuits (ASICs). Unless otherwise specifically noted, the controller is not limited to any specific combination of hardware circuitry and software, nor to any particular source for the instructions executed by the processing unit.

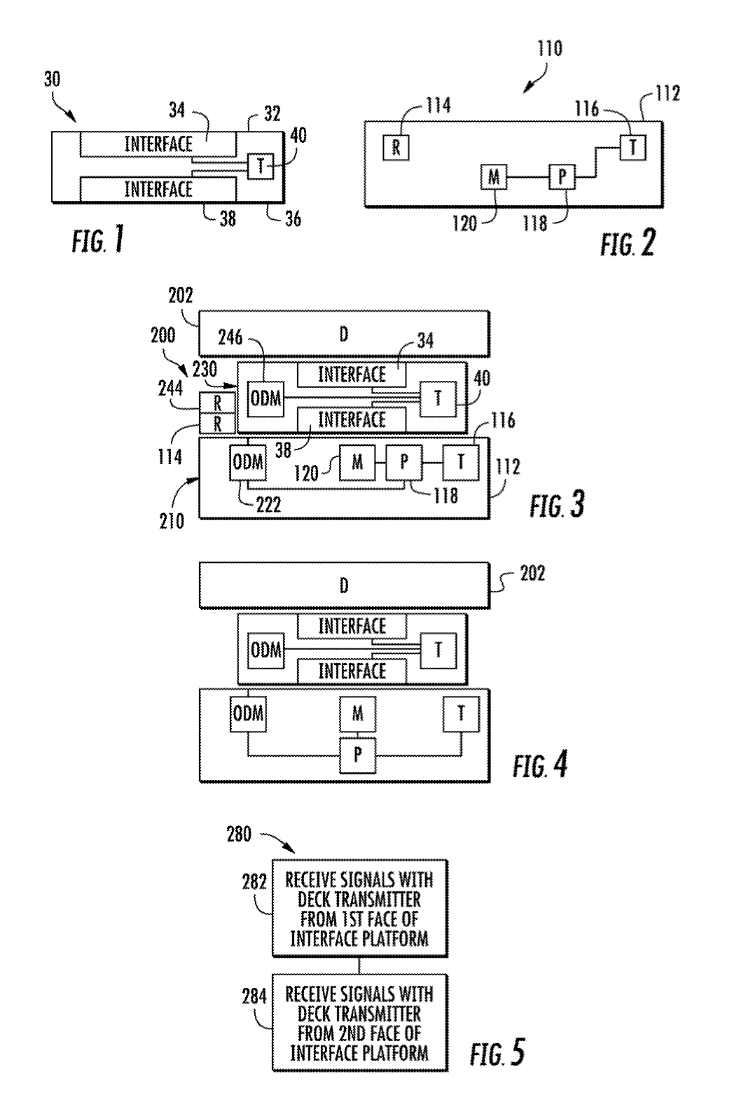

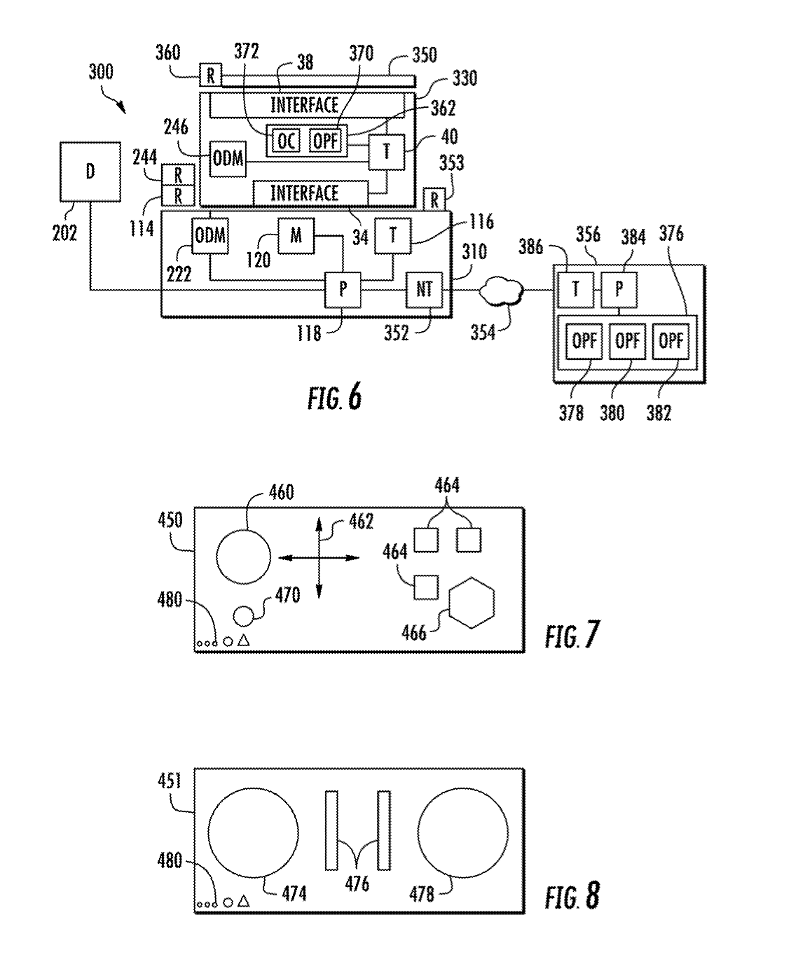

FIGS. 3 and 4 illustrate an example computer device 200. Computer device 200 comprises display 202, deck 210 and interface platform 230. Display 202 comprise a display screen. In one implementation, display 202 is pivotally coupled or hinged to deck 210. In another implementation, deck 202 is supported or contained within the same housing of deck 210.

Deck 210 is similar to deck 110. Deck 210 comprises housing 112, platform retainer 114 and transmitter 116 described above. In the example illustrated, deck 210 additionally comprises orientation detection mechanism 222. Orientation detection mechanism 222 comprises a mechanism configured to detect the orientation or positioning of interface platform 230. Orientation detection mechanism 222 identifies not only when 230 is joined or secured to deck 210, but also identifies the orientation of platform 230 to identify which interlace 34, 38 is facing in an upward direction for use and which interface 34, 38 is facing downwards and not to be used. In one implementation, orientation detection mechanism 222 comprises an optical detector, wherein the different faces of interface platform 230 have different colors, images, codes or other visible indicia which is visibly captured by the optical sensors of mechanism 222 to identify which side or face of platform 230 is facing upward. In another implementation, orientation detection mechanism 222 comprises one or more switches or the like which are differently actuated depending upon which face of interface platform 230 is positioned against deck 222. In some implementations, orientation defection, mechanism 222 may be omitted as part of deck 112 and alternatively be provided as part of interface platform 230. In some implementations, computer device 200 may prompt a user to identify and input which of the two interfaces of interface platform 230 has been selected for use.

Interface platform 230 is similar to interface platform 30 except the interface platform 230 is illustrated as additionally comprising deck retainer 244 and orientation detection mechanism 246. Those remaining elements or components of interface platform 230 which correspond to components of interface platform 30 are numbered similarly. Deck retainer 244 comprise a structure carried by interface platform 230 to releasably secure interface platform 230 deck 210. In one implementation, deck retainer 244 cooperates with a corresponding platform retainer 114 of deck 210.

In one implementation, deck retainer 244 comprises a recess into which a projection of deck 210 is at least partially received. In another implementation, deck retainer 244 comprises one or more posts, columns or other projections which are received within corresponding cavities or bores of deck 210. In yet another implementation, deck retainer 244 comprises a cavity or rhesus into which entire peripheral profile of platform 230 is at least partially received or inset. In yet another implementation, deck retainer 244 comprises one of a tongue and groove, where in interface platform comprise other of the tongue and groove of deck 210, facilitating sliding interconnection and interlocking of interface platform 230 with the associated deck. In yet other implementations, deck retainer 244 may comprise other mechanisms such as latches, snaps, clips or the like to releasably securing interface platform 230 in place relative to a deck, such as deck 210.

Orientation detection mechanism 246 comprises a mechanism configured to detect the orientation or positioning of interface platform 230. Orientation detection mechanism 246 identities nor only when platform 230 is joined or secured to deck 210, but also identifies the orientation of platform 230 to identify which interface 34, 38 is facing in an upward direction for use in which interface 34, 38 is facing downwards and not to be used. Orientation detection mechanism 246 communicates the determined positioning or orientation of interface platform 230 to deck 210 with transmitter 40.

In one implementation, orientation detection mechanism 222 comprises a gyroscope or other level sensing de vice to determine which of interfaces 34, 38 faces up and which of interfaces 34, 38 faces down. In another implementation, orientation detection mechanism 246 comprises an optical detector along each of the two opposing faces 32, 36 of platform 230, wherein the faces 32, 36 of platform 230 positioned against or opposite to deck 210 receives less ambient light, indicating which of feces 32, 36 is positioned against deck 210 and which of faces 32, 36 is facing upward. In another implementation, each of faces 32, 36 may include a different photo emitter which is detected by a corresponding photodetector of deck 210. In another implementation, orientation detection mechanism 246 comprises one or more switches or the like which are differently actuated depending upon which face of interface platform 230 is positioned against deck 222. In some implementations, orientation detection mechanism 246 may be omitted as part of platform 230 and alternatively be provided as part of deck 210. In some implementations, computer device 200 may prompt a user to identity and input which of the two interfaces of interface platform 230 has been selected for use.

FIG. 5 is a flow diagram of an example method 280 that may be carried out using computer device 200 shown in FIGS. 3 and 4. As indicated by block 282 and shown by FIG. 3, transmitter 116 of deck 210 receives signals in response to a user interacting with interface 30 on face 32 of interface platform 230. As noted above, platform 230 is removably attached to and supported by deck 210. As indicated by block 284 and shown by FIG. 4, transmitter 116 of deck 210 receives second signals in response to user interacting with interface 38 along face 36 of interface platform 230. In one implementation, the user simply flips interface platform 230 over from the position shown in FIG. 3 to the position shown in FIG. 4 to utilize interface 38 instead of interface 34. In one implementation, one or both of orientation detection mechanisms 222, 246 automatically identify the flipping of interface platform 230 and communicate this determination to the processor which Utilizes signals from interface platform 230. In another implementation, the user is prompted to input the positioning of interface platform 230. For example, in one implementation, the interface platform 230 and/or deck 210 may include a toggle switch or rocker switch, or other input mechanism, allowing the user to indicate which face of interface platform 230 is facing upwardly in which it interfaces 34, 38 have been selected for use.

FIG. 6 schematically illustrates computer device 300, another implementation of computing device 200. Computer device 300 comprises display 202 (described above) deck 310, interface platform 330 and overlay 350. Deck 310 is similar to deck 210 except that deck 310 additionally comprises network transmitter 352 and overlay retainer 353. Network transmitter 352 comprises a device to send signals to and receive signals from a remote computing node, such as another computing device or server across a network, such as a local area network or a wide area network (the Internet). In the example illustrated, network transmitter 352 is configured to communicate in a wired or wireless fashion across a network 354 with computing node 356 as will be described hereafter. In some implementations, network transmitter 352 is omitted, wherein transmitter 116 communicates across network 354 with remote computing node 356.

Overlay retainer 353 comprises a mechanism carried by deck 310 which is configured to releasably secure overlay 350 in place across interface 38 when platform 330 is secured to deck 310. In one implementation, interface platform 330 is sufficiently recessed within deck 310 such that overlay retainer 353 contacts overlay 350 supported by platform 330. In one implementation, overlay retainer 353 comprises a clip, such as a resilient leaf spring which pinches an edge portion of overlay 350 against an upper surface of deck 310 and/or platform 330. In one implementation, overlay retainer 353 comprises one or more clips along a single dimension to inhibit lifting of overlay 353 away from interface as well as to inhibit horizontal movement of overlay 350 in the single dimension. In another implementation, overlay retainer 353 comprises one or more clips along each of two dimensions to retain overlay 350 against horizontal movement (movement parallel to the plane of interface 38) in both dimensions. In yet another implementation, overlay retainer 353 comprises one or more projections or pins which precisely register within correspondingly located and sized apertures in overlay 350 to inhibit movement of overlay 350 in multiple dimensions parallel to the plane of interface 38 and to also register overlay 350.

User interface platform 330 is similar to user interface platform 230 except that user interface platform 330 additionally comprises overlay retainer 360 and memory 362. Those remaining components of interface platform 330 which correspond to elements or components of interface platform 230 are numbered similarly. Overlay retainer 360 comprises a mechanism carried by platform 330 which is configured to releasably secure overlay 350 in place across interface 38. In one implementation, overlay retainer 360 precisely locates, registers and indexes overlay 350 relative to predefined portions of interface 38 such that individual distinct portions of overlay 350 are aligned with predefined distinct regions are portions of interface 38 when overlay 350 is secured by retainer 360. As a result, particular portions of overlay 350 are precisely matched to predefined regions of interface 38 which are pre-assigned to particular commands or inputs.

In another implementation, overlay retainer 360 holds overlay 350 in place, wherein individual portions of overlay 350, such as distinct printed input graphics on the surface of overlay 350, are subsequently registered during a set up procedure by the user. During set up, computer device 300 may prompt a user to assign different regions of the overlay 350 to different input selections or commands. For example, computer device 300 may prompt or request that the user to select a portion and depress tire selected portion of overlay that is to chosen to correspond to a particular command or selection. Upon such selection and depressment, computer device 390 assigns the portion of the overlay being depressed by the user to the particular command. In such a manner, the user may customize what portions of overlay 350 correspond to particular inputs.

In one implementation, overlay retainer 360 comprises a clip, such as a resilient leaf spring which pinches an edge portion of overlay 350 against an upper surface of platform 330. In one implementation, overlay retainer 360 comprises one or more clips along a single dimension to inhibit lifting of overlay 350 away from interface 38 as well as to inhibit horizontal movement of overlay 350 in the single dimension. In another implementation, overlay retainer comprises one or more cups along each of two dimensions to retain overlay 350 against horizontal movement (movement parallel to the plane of interface 38) in both dimensions (transversely and longitudinally). In yet another implementation, overlay retainer 360 comprises one or more projections or pins which precisely register within correspondingly located in sized apertures in overlay 352 inhibit movement of overlay 350 in multiple dimensions parallel to the plane of interface 38 and to also register overlay 350. In one implementation, platform 330 comprises an overlay retainer 360 proximate to each of interfaces 32, 36 for retaining an overlay 350 relative to the associated interface 38, 34.

In one implementation, each of overlay interfaces 360 may be differently configured for predefined overlay interfaces 350 so to inhibit the use of incorrect overlay interfaces 350 with respect to the particular interface. For example, in one implementations, retainer 360 may comprise a first pattern of pins, a first shaped pin or a first sized pin for retaining and overlay 350 across interface 38 and may comprise a second different pattern of pins, whereas those overlay 350 that art to be used with interface 38 have a corresponding pattern of apertures, a correspondingly shaped aperture or correspondingly sized aperture. In an implementation, retainer 360 also comprises a second different pattern of pins, a second different shaped pin or a second differently sized pin for retaining an overlay 350 across interface 34, whereas those overlays 350 that art to be used with interface 34 have a corresponding second pattern of apertures, a correspondingly shaped second aperture or correspondingly sized second aperture.

Memory 362 comprises a non-transitory computer-readable medium or persistent storage device. Memory 362 comprises overlay print files 370 and overlay credentials 372. Overlay print files 370 comprise files configured to direct a printing device to print different overlays for interfaces 34 and 38. In one implementation, connection of interface platform 330 to deck 310 causes computer device 300 to notify a user of the option to overlay print files 370 contained in memory 362. In one implementation, such selectable overlay print files 370 are transmitted by transmitter 40 to transmitter 116 and are presented on display 202 by processor 118. Upon an individual overlay 350 contained in an overlay print file being selected, processor 118 may utilize such files to cause a printer to print one or more of the selected overlay print files 370 for subsequent use with platform 330.

Overlay credentials 372 do not comprise the actual overlay print files themselves, but comprise credentials, authorizations, passwords, keys, codes or other permissions providing computer device 300 with the ability to retrieve and download or otherwise obtain one or more overlay print files from a remote database or source. In the example illustrated, overlay credentials 372 comprise credentials for facilitating the retrieval of overlay print files from a remote network source 356 across network 354. Upon being connected to deck 310, overlay credentials 372 are transmitted by transmitter 42 transmitter 116, wherein processor 118 utilizes network transmitter 352 and the overlay credentials 372 to obtain one or more overlay print files from remote network source or 356. In the example illustrated, remote network source 356 comprises a remote server having a memory 376 storing overlay print files 78, 380, 382. Remote network source 356 further comprises a processor 384 which reviews the overlay credentials 372 received through transmitter 386. Upon verifying the authenticity of such credentials, processor 384 transmits the one or more selected overlay print files 378, 380, 382 to computer device 300 for subsequent storage and printing by computer device 300 for use with interface platform 330.

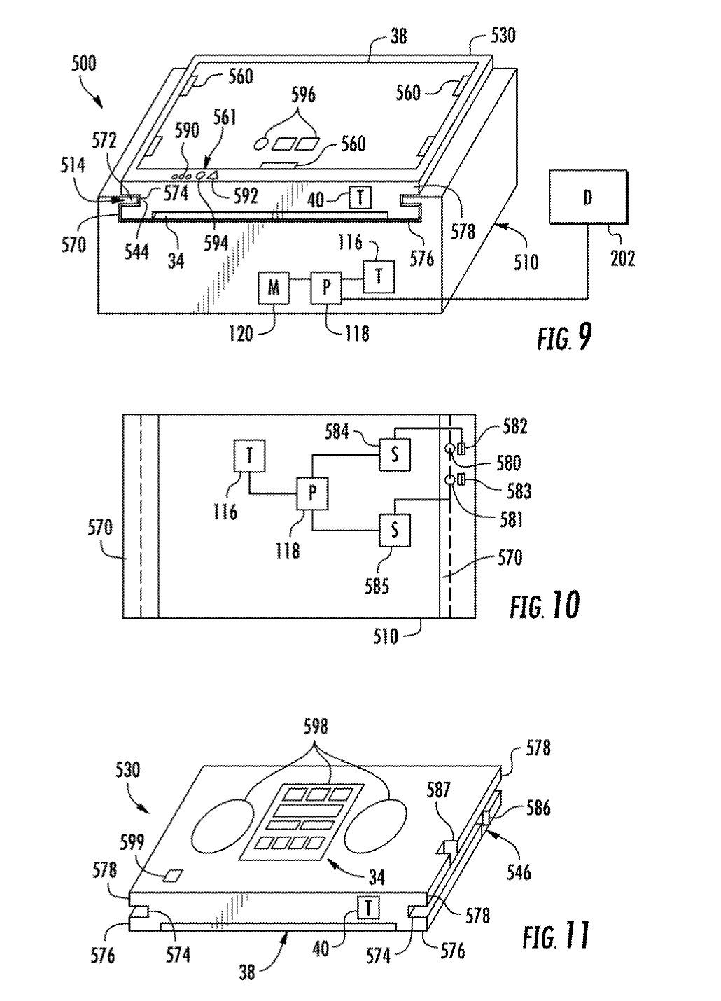

FIGS. 7 and 8 illustrate two example overlays 450 and 451, respectively, example implementations of overlay 350. Each of overlays 450, 451 comprise a thin sheet or panel to be retained in place over interface 38 and/or interface 34. In one implementation, each of overlays 450, 451 comprises an entire sheet or panel that is sufficiently flexible such that an upper surface of the sheet or panel may be manually depressed using force from one or more fingers of a person, wherein such depressment results in the opposite underside or bottom side portion of the sheet also moving to transmit force to the interface 34, 38 being contacted.

In another implementation, each of overlays 450, 451 may comprise a panel or sheet of relatively inflexible rigid material, wherein the sheet or panel comprises openings or windows allowing selected portions of the underlying interface 34, 38 to be contacted and to receive manual force either directly from a person's fingers or fingers or with some other interaction device, such as the stylus. In yet another implementation, the openings or windows are covered by a depressable film or panel, wherein such depressment results in the opposite underside or bottom side portion of the film spanning the window to move so as to transmit force to the interface 34,38 being contacted below the window. In one implementation, the depressable film or panel overlaying the window comprises graphics or text printed thereon to identify the input element.

In one implementation, the sheet or panel forming interface 450, 451 is transparent, facilitating viewing of the underlying graphics or icons of the underlying interlace 34, 38. In some implementations, the transparent sheet or panel may include printed text or graphics. In some implementations, portions of overlay 450, 451 may include an aperture or window or may comprise portions of the sheet that are both depressable and transparent, facilitating concurrent viewing and use of different input graphics or icons printed on both the overlaying overlay 450, 451 and the underlying interface 34, 38. As a result, in some implementations, overlays 450, 451 may be placed upon one of interfaces 34, 38 to supplement the inputs or controls provided by the underlying interface 34, 38, allowing input graphics or elements of both the underlying interface 34, 38 and the overlying overlay 450, 451 to be concurrently utilized.

In the example illustrated in FIG. 7, overlay 450 comprises input icons, symbols or graphics 460, 462, 464, 466 and 470. Such graphics correspond to particular underlying portion of the regions of interface 38 and/or interface 34. When a particular graphic is interacted with, such as being depressed or by sliding one's linger lingers across the interaction region, forces are transmitted to the underlying particular portions of the interface 34, 38, which results in signals being generated and transmitted by transmitter 46 to transmitter 116, wherein processor 118 translates the signals and appropriately responds to such signals. In other implementations, overlay 450 may comprise graphics having other shapes, sizes, layouts and the like.

In the example illustrated in FIG. 8, overlay 451 comprises input icons, symbols or graphics 474, 476 and 478. Such graphics correspond to particular underlying portion of the regions of interface 38 and/or interface 34. When a particular graphic is interacted with, such as being depressed or by sliding one's finger fingers across the interaction region, forces are transmitted to the underlying particular portions of the interface 34, 38, which results in signals being generated and transmitted by transmitter 40 to transmitter 116, wherein processor 118 translates the signals and appropriately responds to such signals. In other implementations, overlay 451 may comprise graphics having other shapes, sizes, layouts and the like.

In some implementations, the graphics of overlay 450 and 451 may be similar to one another or may overlap similar portions of interface 330. In some implementations, interaction with the similarly located or similarly configured graphics may still result in different responses by computer device 300 based upon which of interfaces 34, 38 is being interacted upon, as detected by orientation detection module 222 and/or orientation detection module 246. In some implementations, the graphics may result in similar responses regardless of the orientation of platform 330.

In the example illustrated, each of input overlays 450, 451 comprises an overlay retainer portion 480. Overlay retainer portion 480 cooperates with overlay retainer 360 of platform 332 register the overlay 450, 451 with interface platform 330. In the example illustrated, overlay retainer portion 480 comprises openings or apertures through the sheet or panel, wherein such openings or apertures are to receive correspondingly located, sized and shaped pins or projections extending from platform 330. The pins or projections extending through the openings of retainer portion 480 and inhibit sliding movement of overlay 450, 451 and recites the register overlay 450, 451 with respect to interface 38 (or interface 34). In other implementations, retainer portion 480 may be omitted or may have other configurations.

FIGS. 9-11 illustrate computer device 500, an example implementation of computer device 300. Computer device 500 comprises display 202 (described above), deck 510, interface platform 530 and overlay set 450, 451 (described above). Deck 310 is similar to deck 310 except that deck 510 is specifically illustrated as comprising interface retainer 514 and orientation detection mechanism 522. Interface platform 530 is similar to interface platform 330 except the interface platform 530 is specifically illustrated as comprising interface retainer 544, orientation detection, mechanism 546 and overlay retainers 560, 561. Those remaining components of computer device 500 which correspond to components of computer device 300 are numbered similarly in FIG. 9 or are shown in FIG. 6.

Interface retainers 514, 522 cooperate to releasably secure interface platform 530 to deck 510. In the example illustrated, interface retainers 514, 522 form a tongue and groove mechanism by which deck 510 slidably receives interface platform 530 in either of two opposite vertical orientations, with interface 38 facing upward or with interface 34 facing upward. Interface retainers 514, 522 retain interface platform 530 in place in a vertical dimension and a horizontal dimension. In the example illustrated, interface retainer 514 of deck 510 comprises channel 570 and tongue 572. Interface retainer 522 comprises channel 574 and tongues 576, 578. In other implementations, this relationship may be reversed.

As shown by FIG. 9, channel 574 slidably receives tongue 572. Channel 570 slidably receives either of tongues 576, 578, depending upon the orientation of interface platform 530. Although the tongue and groove arrangement provided by interface retainers 514, 522 is illustrated as extending fore and aft, in other implementations, the tongue and groove arrangement alternatively extends side to side. Although the tongue and groove arrangement is illustrated as extending completely from one edge to the opposite edge, allowing interface platform 530 to be slidably connected to deck 510 from either side, other implementations, one end of the tongue and groove arrangement may be closed, limiting insertion of platform 530 into connection with deck 510 from a designated side of deck 510.

Orientation detection mechanisms 522, 546 comprise mechanisms configured to detect the orientation or positioning of interface platform 330. Orientation detection mechanisms 522, 546 identity not only when platform 530 is joined or secured to deck 510, but also identify the orientation of platform 530 to identify which interface 34, 38 is feeing in an upward direction for use and which interface 34, 38 is facing downwards and not to be used. In the example illustrated, orientation detection mechanisms 522, 546 cooperate with one another to determine the present and orientation of interface platform 330. In the example illustrated, orientation detection mechanisms 522, 546 additionally serve as interface retainers, releasably securing interface platform 530 in an additional horizontal dimension (in the fore and aft direction shown in FIGS. 9-11 ).

FIG. 10 is a top view of deck 510. As shown by FIG. 10, orientation detection mechanism 522 comprises a pair of projections 580, 581, such as balls or pins, resiliently biased by springs 582, 583 into one of channels 570. As schematically shown by FIG. 10, orientation detection mechanism 582 further comprises sensors 584, 585 which detect the positioning of projections 580, 581, respectively. In one implementation, sensors 584, 585 comprise photo emitter-detector pairs. In other implementations, sensor 584, 585 may comprise other types of sensing devices.

As shown by FIG. 11, orientation detection mechanism 546 comprises a pair of apertures or notches 586, 587 formed in tongues 576, 578, respectively. Notch 586 is sized, and located so as to receive projection 580 when tongue 576 is received within channel 570 such that interface 34 is facing in an upward direction. Conversely, Notch 587 is sized and located so as to receive projection 583 when tongue 578 is received within channel the roof 570 such that interface 38 is facing in an upward direction. Sensors 584, 585 detect the positioning of projections 580, 581, thereby detecting the orientation of interface platform 530 relative to deck 510. At the same time, because at least one of projections 580, 581 resiliently pops into and is received by the corresponding notch 586, 587, the user is provided an audible (a clicking sound) or tactile indication of when interface platform 530 has been completely and fully received by deck 510. The projection 580, 581 being received by the corresponding notch 586, 587 further inhibits inadvertent relative sliding of interface platform 530 relative to deck 5102 retain interface platform 530 against inadvertent movement in a horizontal dimension. In other implementations, computer device 300 may include other types of orientation detection mechanisms which are entirely contained within either deck 510 or interface platform 530. For example, gyroscopes may alternatively be utilized to indicate the orientation of interface platform 530 when attached to deck 510.

Overlay retainers 560, 561 comprise a mechanisms carried by platform 530 configured to releasably secure overlay 450 or overlay 451 in place across interface 38. In the example illustrated, overlay retainers 560 comprise clips, such as resilient leaf springs which pinch an edge portion of overlay 450, 451 against an upper surface of platform 530. In the example illustrated, overlay retainers 560 comprise clips along to opposing edges of interface 38 and along a third edge of interface 38 extending between the two opposing edges. As a result, overlay 450, 451 is retained in place in both directions along a transverse side-two-side axis (as seen in FIG. 9) and in one direction along a longitudinal, fore-aft axis.

Overlay retainer 561 comprises one or more projections or pins which precisely register within correspondingly located in sized apertures in overlay 450, 451 to inhibit movement of overlay 450, 451 in multiple dimensions parallel to the plane of interface 38 and to also register overlay 450, 451. In the example illustrated, retainer 561 comprises a pattern of pins 590, a differently shaped pin 592 and a differently sized pin 594 for interacting with corresponding openings 480 of overlay 450, 451 (shown in FIGS. 7 and 8). In other implementations, overlay 450, 451 may comprise pins while interface retainer 561 comprises corresponding detents. In other implementations, other arrangements of patterns, sizes and shapes of pins and apertures may be utilized.

As further shown by FIG. 9, interface 38 comprises one or more input graphics 596. In one implementation, overlay 450 (shown in FIG. 7) comprises a transparent or translucent portion, allowing graphics 596 to be viewed or seen through overlay 450. In such an implementation, the transparent or translucent portion of overlay 450 overlying graphics 596 is flexible, allowing force to be transmitted through overlay 450 to the underlying regions of interface 38 upon which graphics 596 are located. As result, a person may utilize both the input graphics 596 of interface 38 as well as the additional input graphics provided by overlay 450. In yet another implementation, portions of overlay 450 corresponding to input graphics 596 of interface 38 may include windows or cutouts, allowing first to directly interact with graphics 596 and the surface of interface 38 through such windows or cutouts in overlay 450.

FIG. 11 additionally illustrates interface 34. As shown by FIG. 11, interface 34 comprises different input graphics or regions 598 as compared to interface 38 and as compared to overlays 450, 451. As further shown by FIG. 11, in one implementation, interface platform 530 additionally comprises an overlay presence detection mechanism 599 (schematically shown). Mechanism 599 detects or senses the presence of an overlay upon interface 34 or upon interface 38. In one implementation, mechanism 599 comprises an optical sensor located so as to be covered by an overlay when overlays positioned upon platform 530, wherein mechanism 599 detects a change in light received by the sensor as a result of the overlay covering the sensor. In other implementations, mechanism 599 may comprise other devices for sensing the presence or absence of an overlay, such overlay 450 or 451. In yet other implementations, a person using computer device 500 may be prompted or requested to input whether or not an overlay is being using a button, switch or the like or using interface 34, 38.

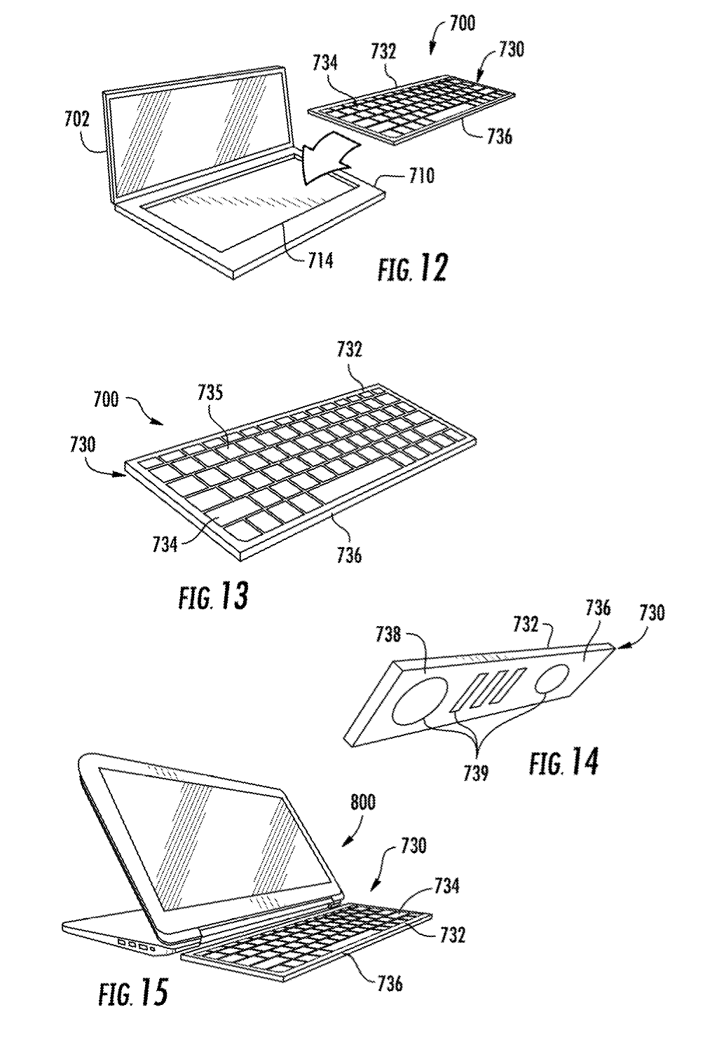

FIG. 12 illustrates computer system 700, another example implementation of computer system 300, Computer system 700 is similar to computer system 300 except that computer system 700 is specifically illustrated as comprising display 702, deck 710 and interface platform 730. Display 702 is similar to display 202 except that display 702 is specifically illustrated as being connected to a front portion of deck 710. In one implementation, display 702 is pivotably connected to or hinged to a front edge of deck 710. In yet another implementation, display 702 is releasably or removably snapped or fastened to deck 710.

Deck 710 is similar to deck 310 except that deck 710 is specifically illustrated as comprising interface platform retainer 714. Those remaining components of deck 710 which correspond to components of deck 310 are numbered similarly in FIG. 12 or are shown in FIG. 6. As shown by FIG. 12, retainer 714 comprises a crater, recess or cavity formed within an upper surface of deck 710. The cavity of retainer 714 is sized and configured to removably receive interface platform 730. In one implementation, the cavity of retainer 734 is sufficiently deep such that an upper surface of interface platform 730, when received within the cavity, is flush with an upper surface of deck 710. In another implementation, the cavity of retainer 714 is sufficiently deep such that an upper surface of interface platform 730, when received within the cavity, is slightly recessed below the upper surface of deck 710, facilitating positioning of display 702 over and across interface platform 730 and against the upper surface of deck 710. In one implementation, platform 730 is recess below the upper surface of deck 710 by a distance of vision such that an overlay, such as overlay 450, 451, is positionable on top of platform 730 and is substantially flush with an upper surface of deck 710, allowing display 702 to be closed over both platform 730 and the overlay 450, 451.

FIGS. 13 and 14 illustrate interface platform 730 in more detail. As shown by FIG. 13, interface platform 730 comprises a first face 732 having interface platform 734. Interface platform 734 comprises keyboard. In the example illustrated, interface platform 734 comprises a plurality of tactile regions 735, formed as rows of keys,, which are sensitive to touch. In the example illustrated, interface 74 comprises a QWERTY keyboard. In other implementations, interface 734 may comprise other types of keyboards.

In one implementation, face 732 of platform 730 is further configured to be at least partially covered by an overlay, such as overlay 450, 451. In such an implementation, the individual tactile sensing regions forming the individual keys of the keyboard of interface 734 serve as distinct sensing regions which underlie individual input graphics provided by the overlay 450, 451. An individual input graphics of overlay 450, 451 may span across several of the individual sensing keys of interface 734. Different clusters or groups of the individual keys or sensing regions of interface 734 may underlie different input graphics of an overlay, such as overlay 450, 451. In such implementations, signals from each of the individual keys of interface 734 are collectively used in combination with one another to identify interaction with the graphic input of the overlay. For example, a person may slide his or her finger across the graphic clement on an overlay, resulting in signals being consecutively produced by different keys of interface 734. Such sliding motion and direction are determined by the computer device based upon the order in which signals are received from the different keys. In one implementation, overlay 450 may be secured on top of face 732. In such an implementation, the #3 tactile sensing region or key underlies the up arrow of graphic 462. The W tactile sensing region or key underlines the left arrow of graphic 462. The R tactile sensing region or key underlies the right arrow of graphic 462. The D tactile sensing region or key underlies the down arrow of graphic 462.

As shown by FIG. 14, in one implementation, platform 730 comprises an opposite face 736 having interface 738. Interface 738 comprises a different set of tactile sensing regions 739 as compared to the tactile sensing regions regions 735. In one implementation, such different tactile sensing region 735 or customized to serve as a disc jockey inputs, gaming inputs, educational program inputs are other operating system compatible input elements. Interface platform 730 allows a person to choose which of interface 734, 738 are to be used by simply changing the orientation of platform 730 or by simply flipping interface platform 730 prior to inserting platform 730 into the cavity of retainer 714.

As shown by FIG. 15, in one implementation, transmitter 40 (shown in FIG. 6 ) of interface platform 730 is a wireless transmitter. In such an implementation, interface platform 730 may be utilized as part of other computer devices independent of a deck, such as deck 710. In such an implementation, transmitter 40 communicates with computing components of the other computer device 800 while interface platform 730 simply rests upon an underlying desk or other supporting surface. Such an implementation, the orientation detection mechanism 246 of interface platform 730 automatically switches between his of interface 734 or interface 738 depending upon the detected orientation of interface platform 730 (which of interfaces 734, 738 is facing upwards). In yet other implementations, interlace platform 730 may include a port or ping allowing interface platform 7302B connected in a wired fashion to the other computer device 800.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
an interface platform for being removably attached to a deck of a computer device, the interface platform comprising:
a transmitter to send signals to and receive signals from the computer device;
a first face having a first user interface; and
a second face having a second user interface different than the first user interface.

2. The apparatus of claim 1, wherein the transmitter comprises a wireless transmitter.

3. The apparatus of claim 1, wherein the first interface comprises a tactile sensing region.

4. The apparatus of claim 3, wherein the second interface comprises a keyboard interface comprising rows of keys.

5. The apparatus of claim 1, wherein the interface platform comprises an overlay retainer to releasably retain an overlay in place over the first interface.

6. The apparatus of claim 1, wherein the interface platform comprises a platform retainer to releasably retain the platform relative to the deck.

7. The apparatus of claim 1, wherein the interface platform comprises a detector to detect and identify an overlay over the first interface.

8. The apparatus of claim 1, wherein the interface platform comprises a memory storing an overlay retrieval mechanism selected from a group of mechanisms consisting of: a graphics file containing instructions for printing an overlay for the interface platform; and credentials to obtain a graphics file containing instructions for printing an overlay for the interface platform from a remote network source.

9. The apparatus of claim 1 further comprising the deck.

10. The apparatus of claim 9, wherein the deck comprises an upwardly facing recess removably receiving the interface platform.

11. The apparatus of claim 9, wherein at least one of the deck and the interface platform comprises an orientation detection mechanism to produce a first signal in response to the interface platform being attached to the deck with the first interface facing upwardly and a second signal different than the first signal in response to the interface platform being attached to the deck with the second interface feeing upwardly.

12. An apparatus comprising:
a computer device deck for releasably supporting an interface platform having a first face with a first user interface and a second face with a second user interface, the deck comprising:
a retaining device to releasably retain the interface platform relative to the deck with a selected one of the first user interface facing upwardly and the second user interface facing upwardly; and
a transmitter to send signals to and receive signals from the interface platform when releasably supported by the deck.

13. The apparatus of claim 12 further comprising:
the interface platform; and
an overlay releasably retained over the interface platform.

14. A method comprising:
receiving first signals with a transmitter in a computer device deck in response to a user interacting with a first face of an interface platform removably supported by the deck; and
receiving second signals with the transmitter in the computer device deck in response to the user interacting with a second face of an interface platform removably supported by the deck.

15. The method of claim 14 further comprising detecting an orientation of the platform relative to the deck.
